(19) United States
(12) Patent Application Publication
(10) Pub. No.: US 2024/0267370 A1
(43) Pub. Date: Aug. 8, 2024

(54) NETWORK BASED DATA EXCHANGE FOR QUALIFYING A USER AND ACTIVATING ACCESS CREDENTIALS

(71) Applicant: MASTERCARD INTERNATIONAL INCORPORATED, Purchase, NY (US)

(72) Inventors: Shawn Mehrhoff, Saint Ann, MO (US); Dan A. Durbin, O'Fallon, MO (US); Pablito Seung Chan Kim Lee, Creve Coeur, MO (US); Nagendar Kishen Surapaneni, Chesterfield, MO (US); David Vorhies, Saint Charles, MO (US)

(21) Appl. No.: 18/164,096

(22) Filed: Feb. 3, 2023

(51) Int. Cl. H04L 9/40; G06Q 20/38

(52) U.S. Cl. CPC H04L 63/083; G06Q 20/3821

(57) ABSTRACT

A computing system including a processor in communication with a memory with instructions stored thereon is described. The instructions, when executed by the processor, cause the processor to receive application data associated with a user and a first offering, identify whether the user qualifies for the first offering, and compare the application data with stored parameters associated with a second offering. The instructions further cause the processor to, based on the application data satisfying the stored parameters, cause display of a first display area and a second display area at a graphical user interface (GUI) of a user computing device wherein the first display area includes a confirmation indicating whether the user qualifies for the first offering, and the second display area includes a description of the second offering, receive an input indicating acceptance of the second offering, and initiate activation of credentials associated with the second offering.

### BACKGROUND

This disclosure relates generally to an exchange of data over computer networks to qualify a user and activate access credentials for the user and, more particularly, to computer systems and computer-based methods for exchanging data over a computer network to qualify a user for an offering by applying stored rules to the exchanged data and activating access credentials of the user who initiated the offering.

Computer systems are used throughout our everyday lives. Multiple computers are networked together so information can be exchanged or communicated from one computer to another. For example, consumers use known computer systems to purchase goods and services, and may apply for a variety of different types of loans. Different processes are implemented by banks or other financial institutions for determining whether to approve or deny a loan. However, in these known cases, the loan application process simply ends with a decision of whether to approve or deny the loan.

Similarly, consumers may use known computer systems to apply for payment card accounts (e.g., credit, debit, etc.). To apply for a payment account, a consumer may be required to again enter data similar to data utilized by banks in determining whether or not to approve or deny a loan. New payment account registration is cumbersome and forces consumers to manually input information, leading to a high percentage of abandoned or incomplete or incorrect applications. Additionally, it is difficult and expensive for issuers of payment card accounts and merchants to direct offers to viable customers as the current model for pre-approval is predominantly treated by customers as spam mail.

A consumer is typically required to re-enter their information when applying for a payment account (e.g., after applying for a loan) in a manual and burdensome process. Utilizing data associated with a consumer for multiple authorizations and/or approvals simplifies known processes for applying for, as examples, loans or payment accounts. Accordingly, improved systems and methods for access credentials are desired. Specifically, systems and methods are needed that automate the exchange of information for a user, identify whether the user qualifies for a first offering (e.g., based on a set of rules), and, at the same time, apply a different set of rules to determine whether the user qualifies for a second offering.

### BRIEF DESCRIPTION

In one aspect, a computing system including at least one memory with instructions stored thereon and at least one processor in communication with the at least one memory is described. The instructions, when executed by the at least one processor, cause the at least one processor to receive application data associated with a user and a first offering via an application programming interface (API), identify whether the user qualifies for the first offering, and compare the application data with one or more sets of stored parameters associated with a second offering. The instructions further cause the at least one processor to, based on the application data satisfying at least one set of the one or more sets of stored parameters and therefore qualifying for the second offering, cause display of a first display area and a second display area at a graphical user interface (GUI) of a user computing device associated with the user wherein the first display area includes a confirmation indicating whether the user qualifies for the first offering, and the second display area includes a description of the second offering along with a user selectable input for responding to the second offering, receive an input indicating acceptance of the second offering based on selection of the user selectable input, and initiate activation of credentials associated with the second offering.

In another aspect, at least one non-transitory computer-readable storage medium with instructions stored thereon is described. The instructions, in response to execution by at least one processor, cause the at least one processor to receive application data associated with a user and a first offering via an application programming interface (API), identify whether the user qualifies for the first offering, and compare the application data with one or more sets of stored parameters associated with a second offering. The instructions also cause the at least one processor to, based on the application data satisfying at least one set of the one or more sets of stored parameters and therefore qualifying for the second offering, cause display of a first display area and a second display area at a graphical user interface (GUI) of a user computing device associated with the user wherein the first display area includes a confirmation indicating whether the user qualifies for the first offering, and the second display area includes a description of the second offering along with a user selectable input for responding to the second offering, receive an input indicating acceptance of the second offering based on selection of the user selectable input, and initiate activation of credentials associated with the second offering.

In yet another aspect, a method for activating access credentials implemented by at least one processor in communication with at least one memory is described. The method includes receiving application data associated with a user and a first offering via an application programming interface (API), identifying whether the user qualifies for the first offering, and comparing the application data with one or more sets of stored parameters associated with a second offering. The method also includes, based on the application data satisfying at least one set of the one or more sets of stored parameters and therefore qualifying for the second offering, causing display of a first display area and a second display area at a graphical user interface (GUI) of a user computing device associated with the user wherein the first display area includes a confirmation indicating whether the user qualifies for the first offering, and the second display area includes a description of the second offering along with a user selectable input for responding to the second offering, receiving an input indicating acceptance of the second offering based on selection of the user selectable input, and initiating activation of credentials associated with the second offering.

### BRIEF DESCRIPTION OF THE DRAWINGS

FIGS. 1-8 show example embodiments of the systems and methods described herein.

FIG. 1 is a simplified block diagram of an access credential (AC) computing system in accordance with one example embodiment of the present disclosure.

FIG. 2 illustrates the AC computing system of FIG. 1 in communication with a multi-party payment processing network.

FIGS. 3A and 3B illustrate a simplified example process for activating an access credential, as implemented using the AC computing system of FIG. 1.

FIG. 4 illustrates a detailed example process for activating an access credential, as implemented using the AC computing system of FIG. 1.

FIG. 5 illustrates an example configuration of a client system, in accordance with the present disclosure.

FIG. 6 illustrates an example configuration of a server system, in accordance with the present disclosure.

FIG. 7 illustrates an example configuration of the AC computing system shown in FIG. 1.

FIG. 8 illustrates an example method for activating an access credential, in accordance with the present disclosure.

### DETAILED DESCRIPTION

Embodiments of the present disclosure include an access credential (AC) computing system and method. For example, payment account offers may automatically be provided to a customer (e.g., a user) upon approval of a loan or other financing mechanism (e.g., or other approval process such as a rent application approval). In the example embodiment, the customer provides customer data (e.g., banking data) via a digital channel for an initial loan that may be approved. The customer may cause or permission that data to be provided by a bank or other financial entity where they have an existing account. For example, the customer may authorize access to the data through an open banking connection with the bank where the customer has the existing account, and the customer data (e.g., any data required for credit decisioning) is electronically pulled or inputted into the AC computing system using APIs between the AC computing device and the customer's bank. In this embodiment, the customer is able to easily provide this data through this API transfer and does not have to manually enter the customer data again. And, if the initial offering of the loan is approved, at least one payment account offering (e.g., associated with at least one payment account; a second offering) is simultaneously provided with a loan approval notification. In the example embodiment, the at least one payment account offer is associated with the same entity (e.g., bank) as the lender. In another embodiment, the payment account offer is associated with a different entity.

The simultaneous approval of the payment account offer along with the loan approval is performed by the AC system (e.g., behind the scenes to the customer) based upon the same customer data used to approve the loan and certain issuer bank parameters that are pre-stored in the AC system. In some embodiments, the loan originator is given priority to offer a payment account to the consumer over other potential payment account issuers. If the loan originator declines to offer a payment account or its parameters (e.g., its credit decisioning parameters pre-stored in the AC system) are not satisfied, other offers from a card/payment account marketplace can be presented to the customer. In some embodiments, if the loan is denied, no payment account offers are presented. In some embodiments, payment account offers are identified and presented to the customer regardless of whether the loan was approved or denied.

If the loan is approved by the system, the loan approval and payment account offers are simultaneously provided (e.g., displayed) to the customer and simultaneously displayed on the user device. The customer can select an enroll button displayed on an interface which triggers instant digital issuance of the payment account by the issuing bank so that the consumer can immediately utilize the payment account or save a digital and/or tokenized version of the payment account in a digital wallet (e.g., before a physical copy of a payment card arrives in the mail).

In the example embodiment, issuers may provide payment account (e.g., card) offers to a marketplace in the AC system. For example, issuers may define parameters (e.g., verification of income, account verification, thresholds associated with different payment account parameters, outstanding debt, credit worthiness, etc.) for credit decisioning and the parameters and/or thresholds may be saved in a database. An AC computing device in the AC system may then integrate connected open banking application programming interfaces (APIs) to receive data reports (e.g., from loan originators) that will be used to for credit decisioning (e.g., and loan decisioning).

In some embodiments, a credit decision may be to pre-approve customers for payment account offers. In some embodiments, the loan originator may be provided a first chance to offer a payment account to the customer (e.g., before other payment account issuers). In some embodiments, if the loan originator declines to offer a payment account to a customer, other offers in the marketplace may be triggered (e.g., from other issuers) and offers associated with issuers whose credit decisioning parameters the customer satisfies (e.g., based on the consumer's credit worthiness) may be presented to the customer.

From the perspective of an acquirer, merchant, and/or payment service provider, a digital point of interaction (POI) for a customer's loan may be integrated with an open banking API and connected to the card marketplace in the AC system (e.g., as controlled by the AC computing device). A POI application may be configured to receive and cause display of card enrollment options after a primary loan associated with a customer is approved.

From a customer perspective, a customer requests a loan via a digital channel (e.g., a lending mobile app, an auto loan via a dealership application on a digital device, etc.). The app on the customer phone may connect with the AC computing device. The customer may authorize/grant the AC computing device access to their banking data (e.g., at a bank currently used by the customer) through an open banking API connection. The open banking APIs allow required data parameters (e.g., income, account balances, etc.) to be transferred into the AC system without the consumer needing to manually enter data (e.g., no need to re-enter data after the data is initially provided for purposes of loan approval).

If the loan offer is approved through the AC system (e.g., the loan originator agrees to loan an amount of money to the user for a predetermine term and rates), any payment account offers may simultaneously be displayed (e.g., for payment accounts whose parameters (e.g., thresholds) the customer (e.g., the customer data) satisfies) along with the loan offer notification. Also displayed is an enroll button (e.g., selector). If the customer selects the enroll button, the AC computing device triggers and causes instant digital issuance of the payment account from the associated issuer. The customer is then able to push provision the card into desired mobile wallets or to tokenized merchants. The customer may also then be able to immediately transact using the payment account (e.g., at card present locations or eCommerce locations).

Accordingly, the AC computing device described herein receives customer data for an initial loan as passed via one or more open banking APIs. The loan originator receives the customer data to make a decision regarding the loan and at the same time the customer data is passed to a payment account (e.g., card) marketplace. Parameters created by issuers in the marketplace and stored in the AC system are used to determine if a payment account will be offered to the customer. In the example embodiment, if the loan is denied, then no payment account offer is presented to the customer while a loan denial notification is presented. If the loan is approved, one or more payment account offers are simultaneously displayed with a loan approval notification.

In other words, the AC computing device may receive application data associated with a user (e.g., a customer) and a first offering (e.g., a loan application including loan application data such as income data associated with the user and address data associated with the user) via an application programming interface (API). The AC computing device may then identify whether the user qualifies for the first offering. For example, the AC computing device may identify whether the user qualifies for the first offering by at least one of i) a message received by the at least one processor (e.g., from an issuer or lender platform) indicating that the user qualifies for the first offering or ii) applying a set of one or more parameters to the application data.

The AC computing device may then compare the application data with one or more sets of stored parameters associated with a second offering (e.g., rules defined by one or more payment account issuers). In some embodiments, the AC computing device may only compare the application data with the one or more sets of stored parameters associated with the second offering if the user qualifies for the first offering. In some embodiments, the AC computing device may first compare the application data with one or more sets of stored parameters associated with second offering of an entity associated with the first offering (e.g., the lender in order to give them priority in the second offering).

The AC computing device may then identify one or more payment account offerings (e.g., associated with respective payment accounts that the user is qualified for based on the application data and the one or more sets of stored parameters) the user is qualified for and, therefore, determine that the user qualifies for the second offering.

The AC computing device may then cause display of a first display area and a second display area at a graphical user interface (GUI) of a user computing device associated with the user wherein the first display area includes a confirmation indicating whether the user qualifies for the first offering, and the second display area includes a description of the second offering along with a user selectable input for responding to the second offering. Again, the entity associated with the first offering may be given priority and have a portion of the second offering associated with them displayed first to the user (e.g., before other offers, as a top option on a list of offers, etc.).

The AC computing device may then receive an input (e.g., from the user computing device) indicating acceptance of the second offering based on selection of the user selectable input (e.g., at the user computing device) and then initiate activation of credentials associated with the second offering.

In some embodiments, the AC computing device may compare the application data with the one or more sets of stored parameters associated with the second offering only if the user qualifies for the first offering (e.g., payment account offers are only presented if the loan application is approved).

In some embodiments, the AC computing device may identify a consent to receive payment account offerings (e.g., wherein the consent is included in the application data and wherein the second offering includes at least one payment account offering) and receive the application data and compare the application data with the one or more sets of stored parameters associated with the second offering in response to identifying the consent.

In some embodiments, the AC computing device may automatically provision a digital version of the payment account. For example, the AC computing device may automatically tokenize the digital version of the payment account and automatically store the tokenized digital version of the payment account (e.g., a token) in a digital wallet associated with the user. The tokenized digital version of the payment account may then be immediately used to initiate payment transactions. Such tokenized data may be exchanged with a merchant (either through a Point of Sale Device or an online website) and combined with other transaction data to generate an authorization message that may be processed through a payment network for completing the purchase transaction.

The technical problems addressed by this system include at least one of: (i) inability of known systems to automatically provide payment account offers based on data initially presented for a different purpose (e.g., a loan application); (ii) inability of known systems to provide a single application for customer consideration of multiple offers (e.g., loan and or payment account offers); (iii) inability of known systems to store and utilize predefined parameters for credit decisioning in a card marketplace wherein various financial institutions (e.g., issuers) may participate; (iv) inability of known systems to present loan decisions and card offers on the same screen; and (v) inability of known systems to activate a payment account upon single click for immediate use and provisioning to a digital wallet.

The methods and systems described herein may be implemented using computer programming or engineering techniques including computer software, firmware, hardware, or any combination or subset thereof, wherein the technical effects may be achieved by performing at least one of the following steps: (i) receiving application data associated with a user and a first offering via an application programming interface (API); (ii) identifying whether the user qualifies for the first offering; (iii) comparing the application data with one or more sets of stored parameters associated with a second offering; based on the application data satisfying at least one set of the one or more sets of stored parameters and therefore qualifying for the second offering: (iv) causing display of a first display area and a second display area at a graphical user interface (GUI) of a user computing device associated with the user wherein the first display area includes a confirmation indicating whether the user qualifies for the first offering, and the second display area includes a description of the second offering along with a user selectable input for responding to the second offering; (v) receiving an input indicating acceptance of the second offering based on selection of the user selectable input; and (vi) initiating activation of credentials associated with the second offering.

The resulting technical effect and/or technical benefits achieved by this system is at least one of: (i) automatically providing payment account offers based on data initially presented for a different purpose (e.g., a loan application); (ii) providing a single application for customer consideration of multiple offers (e.g., loan and or payment account offers); (iii) storing and utilizing predefined parameters for credit decisioning in a card marketplace wherein various financial institutions (e.g., issuers) may participate; (iv) presenting (e.g., causing display of) loan decisions and card offers on the same screen; and (v) activating a payment account upon single click/selection for immediate use and provisioning to a digital wallet.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an example embodiment, the system is executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

The systems and processes are not limited to the specific embodiments described herein. The detailed description illustrates embodiments of the disclosure by way of example and not by way of limitation. In addition, components of each system and each process can be practiced independent and separate from other components and processes described herein. Each component and process can also be used in combination with other assembly packages and processes.

As used herein, the term “payment account” may refer to any suitable payment account, such as an account associated with a payment card, a credit card, a debit card, a prepaid card, a charge card, a membership card, a promotional card, a frequent flyer card, an identification card, a prepaid card, a gift card, and/or any other payment device that may hold payment account information, such as mobile phones, smartphones, personal digital assistants (PDAs), key fobs, and/or computers. Each type of payment device can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

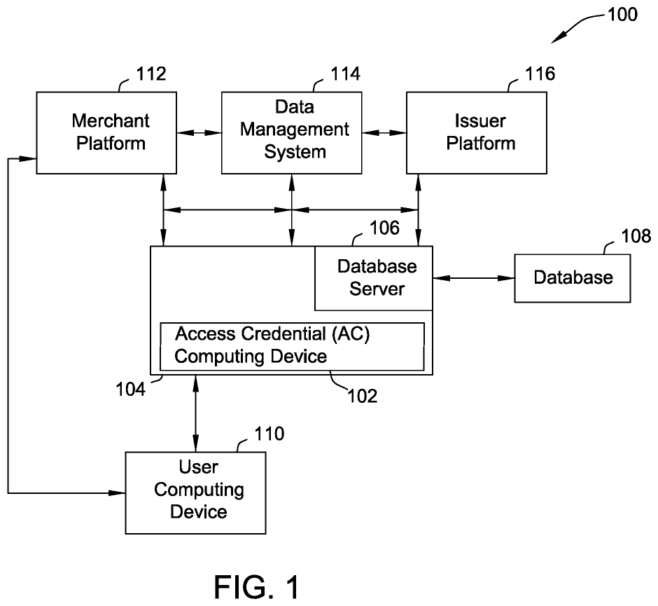

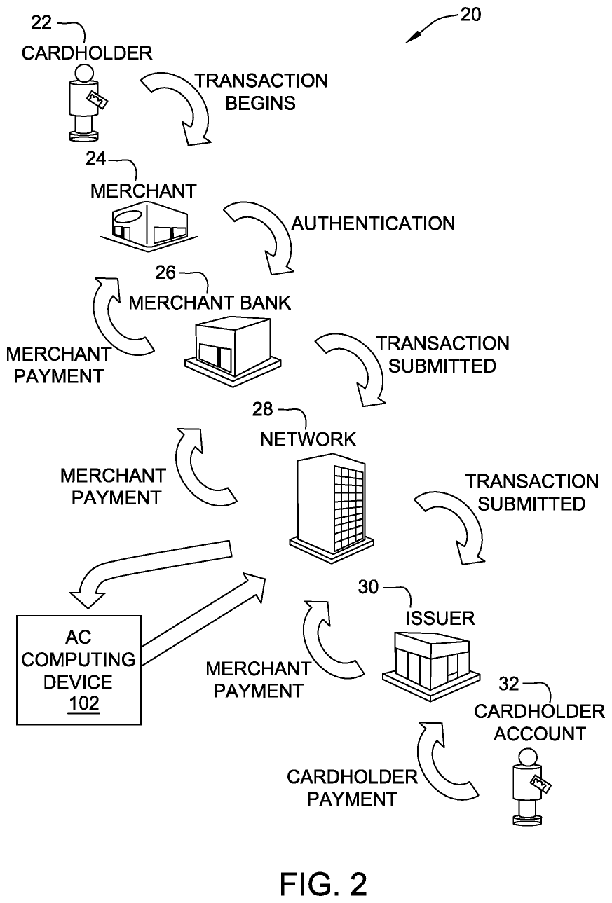

FIG. 1 is a simplified block diagram of an access credential (AC) computing system 100. As shown in FIG. 1, system 100 includes an AC computing device 102. In some embodiments, device 102 is implemented on a server 104. In some embodiments, device 102 includes a database server 106 that facilitates communication between device 102 and a database 108. For example, database 108 may include parameters defined by one or more issuers that are utilized by device 102 in determining which payment account offers to present to a user.

System 100 also includes a user computing device 110 (e.g., smart phone, laptop, etc.) utilized by one or more users when, as examples, applying for a loan or selecting a payment account to create. As shown in FIG. 1, device 110 is in communication with a merchant platform 112. Accordingly, a user at device 110 may apply for a loan by submitting data (e.g., user data such as income, verification of income, account verification, account balances, etc.) to merchant platform 112 (e.g., associated with a merchant where the user is making a purchase that may require or offer a loan).

In the example embodiment, a user may consent to having their user data utilized not only for a loan application, but also for payment account offers. Accordingly, platform 112 may pass the user data to a data management system 114. System 114 may then request and receive user banking data from a bank where the user currently has an account via one or more APIs. System 114 may then transmit, via one or more APIs, the user data to device 102 and an issuer platform 116 (e.g., associated with a loan issuer and/or payment account issuer).

In the example embodiment, platform 116 may be both a loan originator and a payment account issuer. For example, user data may be transmitted from device 110 to platform 116 in order for a loan approval or denial decision to be made at platform 116. The user data may be simultaneously passed to device 102 for payment account offers to be identified.

For example, system 114 passes the user data to device 102 for payment account decisioning. Accordingly, device 102 may utilize the user data (e.g., received from a user bank by system 114 via an API) and issuer data stored in database 108 (e.g., payment account parameters) in order to identify at least one payment account the user is eligible for. Then, device 102 may cause display of a loan notification (e.g., approval or denial) and a notification of at least one payment account the user is eligible for at user computing device 110.

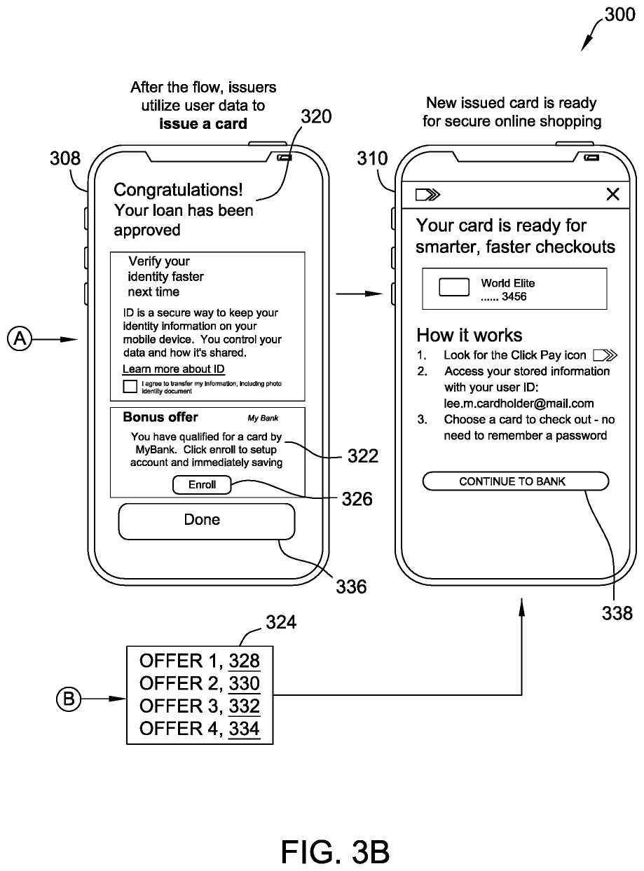

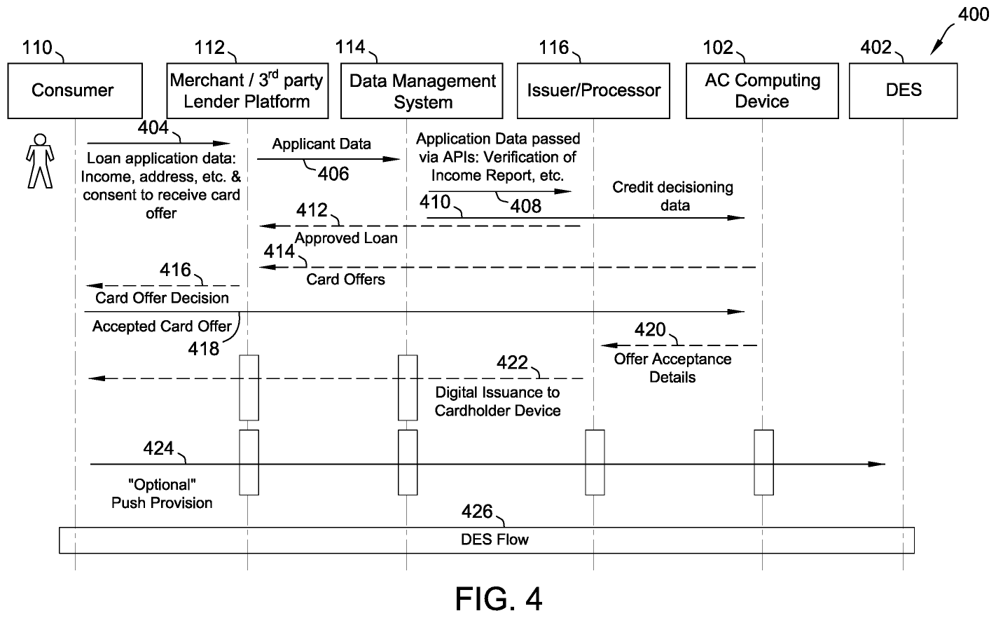

The user may then select, at user computing device 110, a payment account to create. Upon user selection of an account (e.g., at a GUI at device 110, see FIGS. 3A and 3B), device 102 then causes the selected account to be created. For example, device 102 may communicate with a digital enablement service (DES, see FIG. 4 and DES 402) to cause the DES to create the selected account. Upon creation of the account, the user is then able to push provision the card into desired mobile wallets or tokenized merchants (e.g., saving tokenized payment account data on a merchant website/platform).

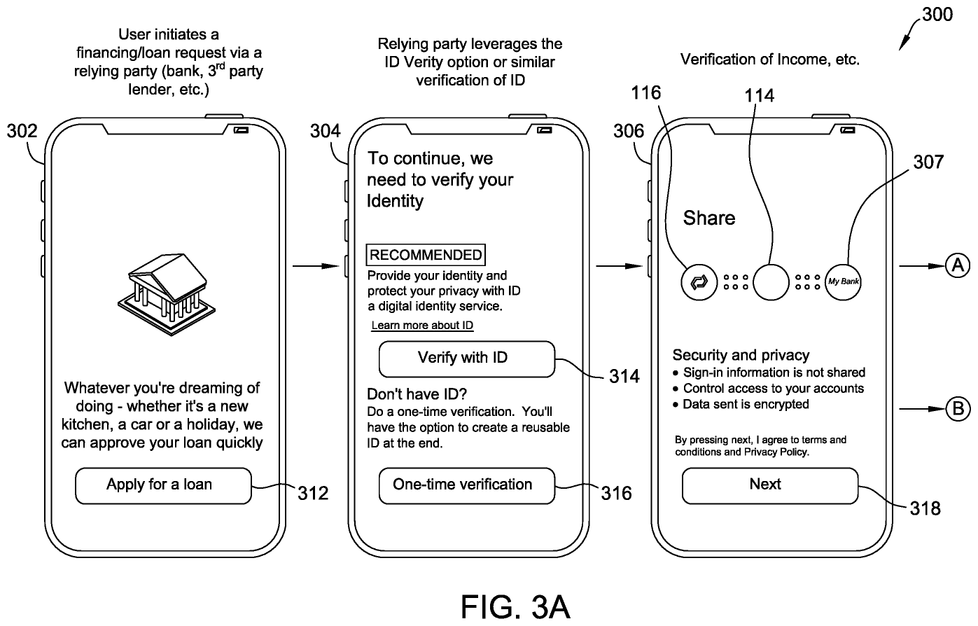

FIG. 2 illustrates AC computing system 100 (e.g., AC computing device 102 thereof) in communication with a multi-party payment processing network 20. Network 20 enables ordinary payment-by-card transactions in which merchants 24 and issuer banks 30 do not need to have a one-to-one special relationship. Embodiments described herein may relate to a payment card system, such as a credit card payment system using the Mastercard® processing network. The Mastercard® processing network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, New York).

In a typical payment card system, a financial institution called the “issuer” issues a payment card, such as a credit card, to a consumer or cardholder 22, who uses the payment card to tender payment for a purchase from merchant 24. To accept payment with the payment card, merchant 24 must normally establish an account with a financial institution that is part of the financial payment system. This financial institution is usually called the “merchant bank,” the “acquiring bank,” or the “acquirer.” When cardholder 22 tenders payment for a purchase with a payment card, merchant 24 requests authorization from an acquirer or merchant bank 26 for the amount of the purchase. The request may be performed over the telephone, but is usually performed through the use of a point-of-sale terminal, which reads cardholder's 22 account information from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using payment processing network 28, computers of merchant bank 26 or merchant processor will communicate with computers of issuer bank 30 by sending a payment transaction authorization request. Based on the payment transaction authorization request, issuer 30 determines whether cardholder's 22 account 32 is in good standing and whether the purchase is covered by cardholder's 22 available credit line. Based on these determinations, the request for authorization will be declined or accepted by issuer 30. If the request is accepted, an authorization code is issued to merchant 24.

When a request for authorization is accepted, the available credit line of cardholder's 22 account 32 is decreased. Normally, a charge for a payment transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment processing network 28 and/or issuer bank 30 stores the payment card information, such as a type of merchant, amount of purchase, date of purchase, in a database.

After a purchase has been made, a clearing process occurs to transfer additional transaction data related to the purchase among the parties to the transaction, such as merchant bank 26, payment processing network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment processing network 28, and then between payment processing network 28 and merchant bank 26, and then between merchant bank 26 and merchant 24.

While the example above relates to transactions, in the example embodiment described herein, payment processing network 28 may be associated with AC computing system 100 and route data to AC computing device 102, as described herein. For example, in embodiments described herein, cardholder 22 (e.g., initially not a cardholder, but a customer/user requesting a loan) may transmit, via device 110, user data when requesting a loan (e.g., to merchant 24, such as merchant platform 112). Merchant 24 and/or merchant bank 26 may then transmit the user data to network 28 (e.g., associated with data management system 114). System 114 may receive that user data, pull user banking data from a user bank via an API, and transmit the user data and the user banking data to device 102 and to issuer 30 (e.g., issuer 116), as part of the loan decisioning and payment account decisioning as described herein. Then, upon offering a payment account to a user and receiving user selection of a payment account, device 102 may cause account 32 to be created.

FIGS. 3A and 3B illustrate a simplified example process 300 for activating an access credential (e.g., a payment account and/or tokenized version of a payment account), as implemented using AC computing system 100 of FIG. 1. Example interfaces 302-310 (e.g., graphical user interfaces (GUIs) and/or screenshots) that are caused/controlled to be displayed by AC computing device 102 on an example computing device 110 (e.g., a mobile phone) are shown in FIGS. 3A and 3B to illustrate example process 300. For example, AC computing device 102 may transmit content to computing device 110 that causes interfaces 302-310 to be displayed.

As shown in FIG. 3A, interface 302 illustrates a first step where a user may select to apply for a loan (e.g., from an example issuer 116) by selection of selector 312. For example, interface 302 may be associated with a relying party such as an issuer. In some embodiments, to access interface 302 a user may be prompted to enter information associated with a user account of the user to log in to an application (“app”) associated with interface 302. For instance, a user may enter a username and password or scan a biometric (e.g., fingerprint, face scan, etc.) at device 110 to log in.

Upon selection of selector 312, interface 304 may be displayed at computing device 110 to prompt a user to verify their identity. For example, a user may be prompted to verify their identity through an identity verification service. In some embodiments, certain user information (e.g., mobile phone number) may be identified automatically while other user information may be required to be verified (e.g., by entry of at least some of a social security number or date of birth). Then, further user data may be transmitted to computing device 110 via an identity verification API (e.g., pre-filled or other known data such as first and last name). The data pulled via the API may then be displayed at device 110 and verified by the user (e.g., by selection of a selector such as selector 314).

In some embodiments, a user (e.g., without an account at an identity verification service) may be prompted to enter user information manually for a one-time verification. For example, upon selection of selector 316 a user may be prompted to enter personal information (e.g., driver's license information) in order to proceed with the one-time verification.

Upon verification of the user identity, certain other information about the user may be verified. For example, interface 306 illustrates that income verification may be performed before advancing to a next step in process 300. In some embodiments, income verification and/or other verifications/approvals required to approve a loan may be performed by lender platform 112 while interface 306 or a similar interface are displayed. As shown at interface 306, user banking data may be pulled from a user bank 307 (“My Bank”) to data management system 114 for sharing with issuer 116.

To advance to a next step in process 300, a user may select selector 318. In some embodiments, a user is made aware that selection of selector 318 includes providing consent for user data to also be shared with AC computing device 102 (e.g., and the card marketplace). In some embodiments, a separate consent may be required to be agreed upon by a user for user data to be shared with AC computing device 102.

As shown in FIG. 3B, upon completion of loan approval (e.g., or denial) and determination of one or more payment accounts the user is qualified for, as explained herein in further detail, interface 308 may be displayed. For example, interface 308 includes a first display area 320 associated with the outcome of the loan approval/denial process and a second display area 322 associated with one or more payment accounts the user is qualified for. Accordingly, the user is made aware not only of the outcome of the loan application process in first display area 320, but additionally of any payment accounts that can be automatically created in display area 322 all on the same interface 308.

In the example of FIG. 3B, second display area 322 may include a single payment account offer while in other embodiments of second display area 324 a plurality of payment account offers may be presented. For example, a payment account associated with the issuer 116 may have priority in being offered to the user. Accordingly, a single payment account offer associated with the issuer 116 may be presented. In some embodiments, if the user declines to create an initially offered payment account, alternative payment accounts the user has qualified for may be presented (e.g., as shown in second display area 324). For example, these alternative payment account offers may not be associated with issuer 116, but rather a different payment account issuer.

In some embodiments, a plurality of payment account offers may be initially presented to a user instead of a single offer having priority and being displayed first. For example, second display area 324 may be displayed on interface 308 in place of second display area 322. In embodiments where second display area 324 is displayed, the order in which payment account offers are presented (e.g., top to bottom, left to right, etc.) may be determined by AC computing device 102 based on user data associated with the user.

For example, analysis of certain user data may indicate that the user may prefer certain payment accounts over others. In some embodiments, user data pulled from user bank 307 may be utilized to identify user interests. For example, data from user bank 307 may indicate user spend amounts in different areas of interest. As one example, the data from bank 307 may indicate high user spend in one or more particular areas of interest (e.g., travel, dining, concerts, sports, other entertainment, etc.). Accordingly, AC computing device 102 may prioritize presenting offers to users that better suit the user based on the received data (e.g., an airline card or hotel card for users with high travel spend, etc.). Accordingly, the accounts the user may prefer over others may be presented first (e.g., higher on the list) than other offers.

In some embodiments, details regarding payment accounts associated with selectors 326-334 may be displayed so that the user may make a more informed decision (e.g., interest rate, benefits such as point multipliers, why the offer is being presented to the user (e.g., based on user interests as determined based on received user data)). In some embodiments, AC computing device 102 may sort/filter which potential payment account offers to apply the user data to (e.g., which sets of rules to apply the user data to) on the front end so that the user data is only applied to certain potential payment account offers (e.g., to limit the number of potential offers and for saving computer resources and increasing computer efficiency). In some embodiments, AC computing device 102 may sort/filter which payment account offers, of the payment account offers of which the user data satisfied, to present to the user (e.g., if a high number of payment account offers are satisfied, those identified by AC computing device 102 as being more appealing to the user than others may first be presented). In some embodiments, machine learning and/or artificial intelligence techniques may be utilized to determine/identify which payment account offers to present to a user and in which order. For example, which payment account offers to present to a user and/or the order in which payment account offers are presented are determined based in part upon machine learning and/or artificial intelligence techniques. Further, machine learning and/or artificial intelligence techniques may be utilized to better sort/filter which potential payment account offers to apply the user data to (e.g., on the front end).

As explained elsewhere herein in further detail, a user may then select a payment account the user would like created. In the example embodiment, the selected payment account is created with a single selection (e.g., click or finger tap) by the user. For instance, a user may select a selector 326 associated with a first offer or, in embodiments where second display area 322 is displayed, any of selectors 328-334 wherein each of selectors 326-334 are associated with a respective payment account offer.

Upon selection of any of selectors 326-334, a payment account associated with the selected selector is automatically caused/controlled to be created by AC computing device 102 as shown at interface 310 (e.g., in some embodiments in response to selection of selector 336 indicating that the user is finished viewing interface 308). For example, as explained herein in further detail, AC computing device 102 may cause an electronic version of the payment account to be automatically created such that the user may immediately/instantly start using the payment account. In some embodiments, account information is provided to a user at user computing device 110 (e.g., card number, expiration date, card verification value (CVV)). For example, the user may be provided with the account information upon selection of selector 338 instead of having to wait for a physical card to arrive in the mail. In some embodiments, AC computing device 102 may cause a tokenized version of the payment account to be created and stored in a digital wallet associated with the user as explained herein in further detail.

FIG. 4 illustrates a detailed example process 400 for activating an access credential, as implemented using AC computing system 100 of FIG. 1. As shown in FIG. 4, process 400 is implemented by user computing device 110, merchant platform 112, data management system 114, issuer platform 116, AC computing device 102, and a digital enablement service (DES) 402.

Process 400 may begin with a user inputting data and/or selecting certain selectors (e.g., as explained above with respect to FIGS. 3A and 3B) in order to complete a loan application. Accordingly, loan application data 404 (e.g., income, address, etc.) is transmitted to merchant platform 112 for processing. In some embodiments, application data 404 includes a consent of the user to receive payment account offers (e.g., in addition to receiving the outcome of the loan verification process). Merchant platform 112 then provides applicant data 406 regarding the user to data management system 114. For example, application data 404 and other data regarding the user known by merchant platform 112 may be compiled into applicant data 406.

Data management system 114 then verifies certain information included in applicant data 406 and pulls further data from a current user bank (e.g., bank 307) as required by issuer 116. System 114 then transmits at least a portion 408 of applicant data 406 and data pulled from the user bank to issuer platform 116 (e.g., via an API) in order for issuer platform 116 to determine a loan application outcome (e.g., approval or denial of a loan). Further, data management system 114 transmits a second portion 410 of applicant data 406 to AC computing device 102 (e.g., via an API) in order for AC computing device 102 to identify which, if any, payment account offers to present to the user. Notably, the user does not have to re-enter data in order for payment account offers to be generated. Rather, at least a portion of the data utilized in the loan application process is also utilized by AC computing device 102 in order to determine which payment account offers to present to the user, as described herein. In some embodiments, the same data is utilized by issuer 116 and device 102.

Upon determining a loan application outcome, issuer platform 116 transmits loan application outcome data 412 (e.g., indicating approval or denial of a loan) to merchant platform 112. Further, AC computing device 102 transmits payment account offer data 414 (e.g., including one or more payment account offers the user is qualified for) to merchant platform 112. Merchant platform 112 then transmits decisioning data 416, indicating the loan application outcome and any payment account offers the user is qualified for) to user computing device 110 for display (e.g., at interface 308).

As shown in FIG. 4, a user may then select a payment account offer at user computing device 110 (e.g., by selection of one of selectors 326-334) regarding acceptance of a payment account to be created for the user with the lender at issuer platform 116 also providing the loan. User computing device 110 then transmits an accepted payment account offer message 418 to AC computing device 102 indicating the payment account selected by the user. AC computing device 102 then transmits acceptance data 420 (e.g., regarding the selected payment account offer) to issuer platform 116. For example, acceptance data 420 may cause the selected payment account to be created at issuer platform 116. Upon creation of the selected payment account, a digital version of the payment account 422 is transmitted to user computing device 110 so that the payment account can be immediately/instantly used by the user in real-time and/or near real-time.

In embodiments where the payment account issuer is different from issuer 116, system 114 may transmit necessary user data to the issuer of the payment account while also vouching for user qualifications (e.g., verified income) indicating the user is eligible to be issued a payment account by the payment account issuer (e.g., that the user data satisfies rules associated with the payment account issuer at device 102 (e.g., in the card marketplace)).

In some embodiments, the user may be able to select (e.g., by selecting a selector at an interface) to receive a tokenized version of the payment account (e.g., a token). In some embodiments, the tokenized version of the payment account may automatically be generated (e.g., an transmitted to the user computing device 110 as part of digital version of the payment account 422 such that the tokenized version is stored in a digital wallet associated with the user).

For example, a push provision message 424 may be transmitted from user computing device 110 to DES 402. In the example embodiment, message 424 includes user registration details associated with the created payment account. For instance, message 424 may include a Primary Account Number (PAN) of the payment account, and/or other payment account information such as CVV (card verification value) and expiration date. Upon receipt of message 424, DES generates an alternative payment account number referred to as a “token” 426 (e.g., tokenization of the payment account occurs). Token 426 is transmitted from DES 402 to user computing device 110 and is securely stored in association with a digital wallet application at user computing device 110. Token 426 is also stored by the DES 402 in association with the PAN of the payment account.

Having registered the payment card details with DES 402 and received the corresponding token at user computing device 110, the user can now use the token 426 to make payments (e.g., for goods and/or services from a merchant). For example, the user may make a face-to-face request of a salesperson of merchant 24, indicating that they wish to purchase specific goods and/or services. The technical payment process whereby the user pays for those goods and/or services is initiated by the merchant.

First, the salesperson of merchant 24 uses some form of interactive POS device, which is commonly an electronic cash register with a touchscreen interface, into which the salesperson provides inputs indicating the goods and/or services to be purchased. Usually, the POS device will retrieve or calculate the relevant transaction amount. In some instances, the POS device is coupled to a mounted NFC-enabled POS reader, but commonly this is not the case, and the salesperson must locate an independent hand-held NFC-enabled POS terminal/reader (often these costly devices are used by multiple salespersons and are not necessarily immediately available, or always available in the same location within the merchant's premises). In the latter case, the salesperson must also manually type the transaction amount into the POS terminal/reader before presenting it to the user.

In either case, once the NFC-enabled POS terminal/reader has received the transaction amount information, and the user may place user computing device 110 in close proximity to the NFC-enabled POS terminal/reader so that the latter can securely obtain token 426 from user computing device 110 (e.g., via an NFC chip of user computing device 110).

The POS terminal may send a transaction request message including token 426 and the transaction amount to merchant bank 26, effectively asking merchant bank 26 to initiate, if possible, the transaction. In turn, the merchant bank 26 may send a corresponding transaction request to DES 402 via a corresponding card provider network (e.g., network 28). DES 402 may then use token 426 to look up the user's corresponding actual payment card account number (PAN) (e.g., the token value is mapped to the user's PAN). The PAN and transaction amount are then forwarded to issuer 30 for approval.

Assuming that the user's account is in good standing, and has sufficient funds to cover the requested transaction amount, issuer 30 approves the transaction and informs network 28 (e.g., and DES 402) of the approval, which in turn informs the merchant bank 26, which in turn sends a corresponding message to the POS terminal of merchant 24 to inform merchant 24 (and the user) that the transaction has been approved. In some embodiments, network 28 and/or DES 402 sends a corresponding message to user computing device 110, informing the user of the approved transaction (e.g., causing display of a transaction amount and a partially masked PAN via an interface at user computing device 110. Notably, the description herein applies equally to other payment services which may employ alternative digital wallet applications and/or tokenization systems.

In other words, AC computing device 102 may receive application data associated with a user (e.g., a customer) and a first offering (e.g., a loan application including loan application data such as income data associated with the user and address data associated with the user) via an application programming interface (API). AC computing device 102 may then identify whether the user qualifies for the first offering. For example, AC computing device 102 may identify whether the user qualifies for the first offering by at least one of i) a message received by the at least one processor (e.g., from issuer platform 116) indicating that the user qualifies for the first offering or ii) applying a set of one or more parameters to the application data.

AC computing device 102 may then compare the application data with one or more sets of stored parameters associated with a second offering (e.g., rules defined by one or more payment account issuers). In some embodiments, AC computing device 102 may only compare the application data with the one or more sets of stored parameters associated with the second offering if the user qualifies for the first offering. In some embodiments, AC computing device 102 may first compare the application data with one or more sets of stored parameters associated with second offering of an entity associated with the first offering (e.g., the lender in order to give them priority in the second offering, if that lender also provides payment account offers (e.g., payment cards)).

AC computing device 102 may then identify one or more payment account offerings (e.g., associated with respective payment accounts that the user is qualified for based on the application data and the one or more sets of stored parameters) the user is qualified for and, therefore, determine that the user qualifies for the second offering.

AC computing device 102 may then cause display of a first display area and a second display area at a graphical user interface (GUI) of user computing device 110 associated with the user wherein the first display area includes a confirmation indicating whether the user qualifies for the first offering, and the second display area includes a description of the second offering along with a user selectable input for responding to the second offering. Again, the entity associated with the first offering may be given priority and have a portion of the second offering associated with them displayed first to the user (e.g., before other offers, as a top option on a list of offers, etc.).

AC computing device 102 may then receive an input (e.g., from user computing device 110) indicating acceptance of the second offering based on selection of the user selectable input (e.g., at user computing device 110) and then initiate activation of credentials associated with the second offering.

In some embodiments, AC computing device 102 may compare the application data with the one or more sets of stored parameters associated with the second offering only if the user qualifies for the first offering (e.g., payment account offers are only presented if the loan application is approved).

In some embodiments, AC computing device 102 may identify a consent to receive payment account offerings (e.g., wherein the consent is included in the application data and wherein the second offering includes at least one payment account offering) and receive the application data and compare the application data with the one or more sets of stored parameters associated with the second offering in response to identifying the consent.

In some embodiments, AC computing device 102 may automatically provision a digital version of the payment account. For example, AC computing device 102 may automatically tokenize (e.g., or cause tokenization of) the digital version of the payment account and automatically store the tokenized digital version of the payment account (e.g., a token) in a digital wallet associated with the user.

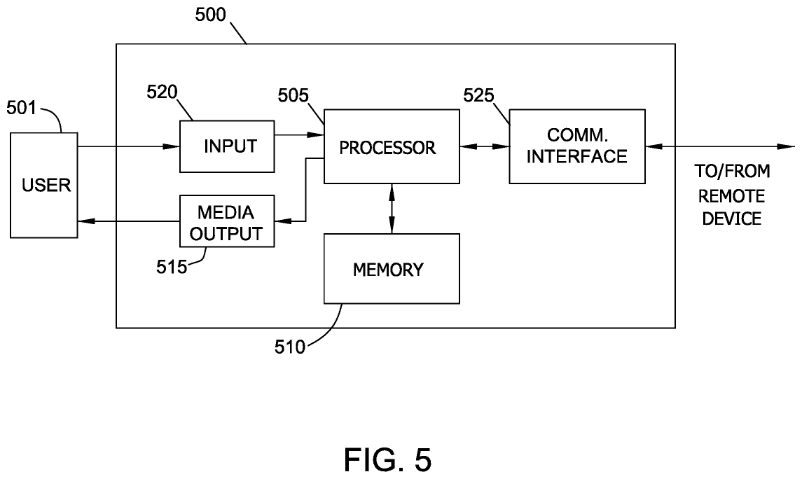

FIG. 5 illustrates an example configuration a client system 500 operated by a user 501. In some embodiments, client system 500 is an example of user computing device 110. In the example embodiment, client system 500 includes a processor 505 for executing instructions. In some embodiments, executable instructions are stored in a memory area 510. Processor 505 may include one or more processing units, for example, a multi-core configuration. Memory area 510 is any device allowing information such as executable instructions and/or written works to be stored and retrieved. Memory area 510 may include one or more computer readable media.

Client system 500 also includes at least one media output component 515 for presenting information to user 501. Media output component 515 is any component capable of conveying information to user 501. For example, media output component 515 is configured to display interfaces 302-310 (shown in FIGS. 3A and 3B) to user 501. In some embodiments, media output component 515 includes an output adapter such as a video adapter and/or an audio adapter. An output adapter is operatively coupled to processor 505 and operatively coupleable to an output device such as a display device, a liquid crystal display (LCD), organic light emitting diode (OLED) display, or “electronic ink” display, or an audio output device, a speaker or headphones.

In some embodiments, client system 500 includes an input device 520 for receiving input from user 501. Input device 520 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 515 and input device 520. Client system 500 may also include a communication interface 525, which is communicatively coupleable to a remote device such as server system 600. Communication interface 525 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

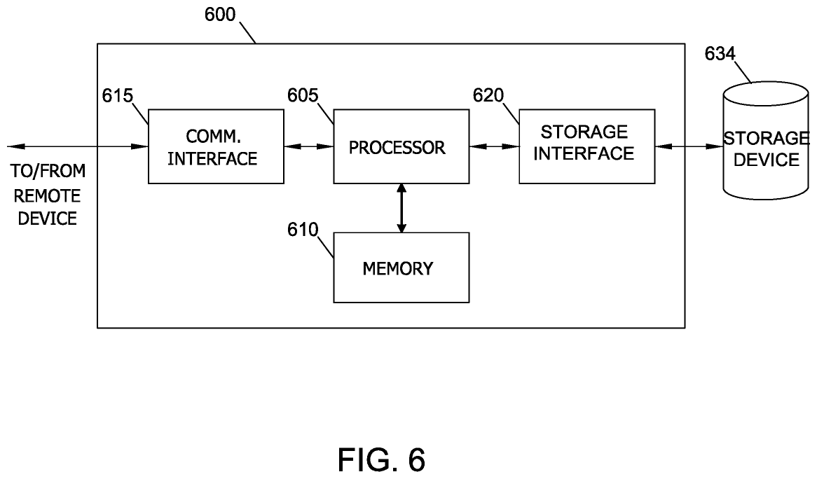

FIG. 6 illustrates an example configuration of server system 600, in accordance with the present disclosure. In some embodiments, server system 600 may be an example of any of AC computing device 102, lender platform 112, data management system 114, and/or issuer platform 116. In some embodiments, each of AC computing device 102, lender platform 112, data management system 114, and/or issuer platform 116 runs on separate server systems 600 communicatively coupled to each other. In some embodiments, any of AC computing device 102, lender platform 112, data management system 114, and/or issuer platform 116 may run on the same server system 600. In the example embodiment, user 501 (shown in FIG. 5) interacts with server system 600, and processes such process 300 and/or process 400, using one of client systems 500 (shown in FIG. 5).

Server system 600 includes a processor 605 for executing instructions. Instructions may be stored in a memory area 610, for example. Processor 605 may include one or more processing units (e.g., in a multi-core configuration) for executing instructions. The instructions may be executed within a variety of different operating systems on the server system 600, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 605 is operatively coupled to a communication interface 615 such that server system 600 is capable of communicating with remote devices such as client systems 500 (shown in FIG. 5) or another server system 600. For example, communication interface 615 may receive requests from client system 500 via the Internet.

Processor 605 may also be operatively coupled to a storage device 634, which may be used to implement a database. Storage device 634 is any computer-operated hardware suitable for storing and/or retrieving data. In some embodiments, storage device 634 is integrated in server system 600. For example, server system 600 may include one or more hard disk drives as storage device 634. In other embodiments, storage device 634 is external to server system 600 and may be accessed by a plurality of server systems 600. For example, storage device 634 may include multiple storage units such as hard disks or solid-state disks in a redundant array of inexpensive disks (RAID) configuration. Storage device 634 may include a storage area network (SAN) and/or a network attached storage (NAS) system.

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Memory area 610 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

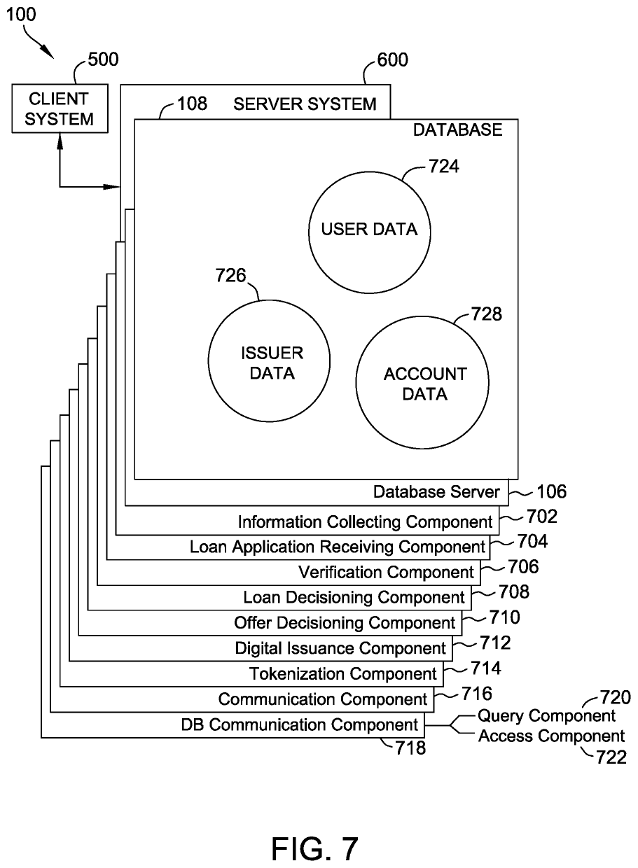

FIG. 7 illustrates an example configuration of AC computing system 100 shown in FIG. 1. Database 108 is coupled to several separate components within AC computing system 100, which perform specific tasks. In the example embodiment, server system 600, database server 106, and database 108 are all contained in a single computing device. In other embodiments, server system 600, database server 106, and database 108 may be contained in separate computing devices which are communicatively coupled to each other.

AC computing system 100 in the some embodiments includes an information collecting component 702 for collecting and storing information from users and/or user banks, a loan application receiving component 704 for receiving loan application data (e.g., from user computing device 110 and/or merchant platform 112), a verification component 706 to verify at least a portion of the loan application data, a loan decisioning component 708 to determine loan application outcomes (e.g., approval and/or denial of a loan), and a payment account offer decisioning component 710 to identify payment account offers the user is eligible for (e.g., based on the loan application data).

AC computing system 100 further includes a digital issuance component 712 for digital issuance of payment accounts and a tokenization component 714 for tokenization of payment accounts, as described herein. AC computing system 100 also includes a communications component 716 for transmitting messages between components and/or devices (e.g., as shown in FIG. 4).

AC computing system 100 also includes a database communication component 718 that includes a query component 720 programmed to receive a specific data (e.g., loan application data), and an access component 722 to access database 108. Query component 720 is programmed for receiving a specific query, a data request and/or a data message (collectively referred to as a “query”) from one of a plurality of devices (e.g., loan application data via an API). Database communication component 718 searches and processes received queries against database 108 containing a variety of information (e.g., rules) associated with one or more payment account issuers regarding potential payment account offers. In some embodiments, database 108 is divided into a plurality of sections, including but not limited to, a user data section 724 (e.g., storing information regarding one or more users), an issuer data section 726 (e.g., storing rules associated with payment account offers), and an account data section 728 (e.g., storing data regarding one or more payment accounts and/or tokens). In some embodiments, the sections within database 108 are interconnected to update and retrieve the information as required.

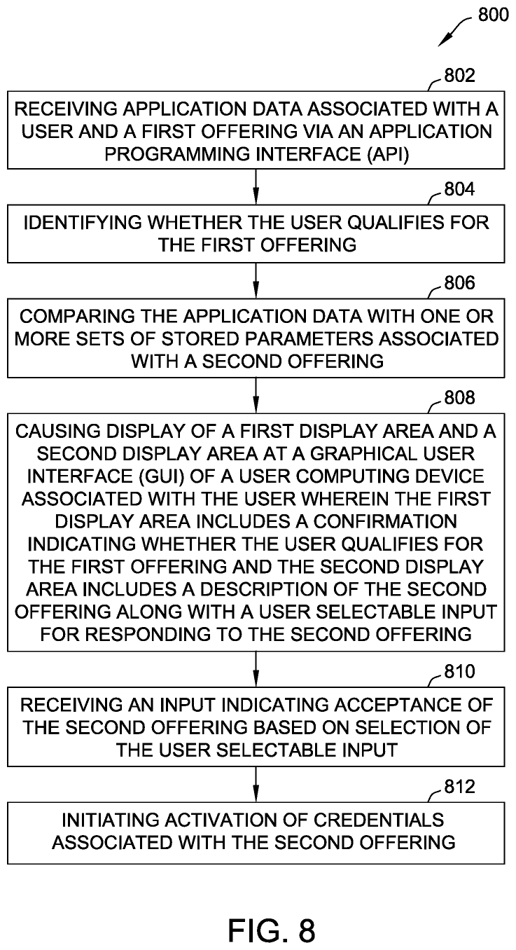

FIG. 8 illustrates an example method 800 for activating an access credential, in accordance with the present disclosure. In the example embodiment, method 800 includes receiving 802 application data associated with a user and a first offering via an application programming interface (API), identifying 804 whether the user qualifies for the first offering, and comparing 806 the application data with one or more sets of stored parameters associated with a second offering. Method 800 also includes, based on the application data satisfying at least one set of the one or more sets of stored parameters and therefore qualifying for the second offering, causing display 808 of a first display area (e.g., display area 320) and a second display area (e.g., display area 322 and/or 324) at a graphical user interface (GUI) of a user computing device associated with the user wherein the first display area includes a confirmation indicating whether the user qualifies for the first offering, and the second display area includes a description of the second offering along with a user selectable input for responding to the second offering, receiving 810 an input indicating acceptance of the second offering based on selection of the user selectable input (e.g., any of selectors 326-334), and initiating 812 activation of credentials associated with the second offering.

In some embodiments, method 800 includes identifying whether the user qualifies for the first offering based on at least one of i) a message received by the at least one processor indicating that the user qualifies for the first offering or ii) applying a second set of one or more parameters to the application data.

In some embodiments, method 800 includes causing a digital version of the credentials to be tokenized into a tokenized digital version of the credentials and automatically storing the tokenized digital version of the credentials in a digital wallet associated with the user.

In some embodiments, method 800 includes identifying a consent to receive payment account offerings, wherein the consent is included in the application data and wherein the second offering includes at least one payment account offering and receiving the application data and compare the application data with the one or more sets of stored parameters associated with the second offering in response to identifying the consent.

As used herein, “machine learning” refers to statistical techniques to give computer systems the ability to “learn” (e.g., progressively improve performance on a specific task) with data, without being explicitly programmed for that specific task. For example, a processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models (e.g., a single model or be separate models) may be created based upon example inputs in order to make valid and reliable predictions for novel inputs (e.g., regarding which offers to present to a user).

Additionally or alternatively, the machine learning programs may be trained by inputting sample data sets or certain data into the programs. For example, training data may include which offers are presented to users and which offers are selected by users to identify how certain user data, such as high user spend in one or more particular areas of interest (e.g., travel, dining, concerts, sports, other entertainment, etc.), correlates to which offers users select. Accordingly, based on the machine learning, offers presented to users may be prioritized based on offers that better suit the user (e.g., offers the user may prefer over others may be presented first (e.g., higher on the list) than other offers).

The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output (e.g., which offers a user is eligible for and/or which offers should be presented to a user). In unsupervised machine learning, the processing element may be required to find its own structure in unlabeled example inputs.

In other words, the machine learning programs may be trained by inputting sample data sets or certain data into the programs. For example, training data may include historical spend patterns for a plurality of different customers where those customers use different payment cards when making those purchases. This historical data may be used to build and/or train different models for predicting which offers are to be presented to customers. If a particular customer mostly closely fits into a cluster of other customers (spend patterns) who have previously selected certain payment card offers in the past, then those same cards may be offered to the particular customer. Machine learning techniques may be used to build these models that cluster current customers so that offers can be better customized for the customer. In some embodiments, the AC computing device may apply these machine learning programs to sort/filter which potential payment account offers to apply the user data to (e.g., which sets of rules to apply the user data to) on the front end so that the user data is only applied to certain potential payment account offers (e.g., to limit the number of potential offers and for saving computer resources and increasing computer efficiency). In some embodiments, the AC computing device may apply these machine learning programs to sort/filter which payment account offers, of the payment account offers of which the user data satisfied, to present to the user (e.g., if a high number of payment account offers are satisfied, those identified by AC computing device 102 as being more appealing to the user than others may first be presented).

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, e.g., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “computing” and/or “cloud computing” and related terms, e.g., “cloud computing devices” may refer to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” and/or “user computing device” may refer to any computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing system comprising:
at least one memory with instructions stored thereon and;
at least one processor in communication with the at least one memory, wherein the instructions, when executed by the at least one processor, cause the at least one processor to:
receive application data associated with a user and a first offering via an application programming interface (API);
identify whether the user qualifies for the first offering;
compare the application data with one or more sets of stored parameters associated with a second offering;
based on the application data satisfying at least one set of the one or more sets of stored parameters and therefore qualifying for the second offering:
cause display of a first display area and a second display area at a graphical user interface (GUI) of a user computing device associated with the user, wherein the first display area comprises a confirmation indicating whether the user qualifies for the first offering, and the second display area comprises a description of the second offering along with a user selectable input for responding to the second offering;
receive an input indicating acceptance of the second offering based on selection of the user selectable input; and
initiate activation of credentials associated with the second offering.

2. The computing system of claim 1, wherein the instructions further cause the at least one processor to identify whether the user qualifies for the first offering based on at least one of i) a message received by the at least one processor indicating that the user qualifies for the first offering or ii) applying a second set of one or more parameters to the application data.

3. The computing system of claim 1, wherein the instructions further cause the at least one processor to compare the application data with the one or more sets of stored parameters associated with the second offering when the user qualifies for the first offering.

4. The computing system of claim 1, wherein the instructions further cause the at least one processor to initiate activation of the credentials by automatically provisioning a digital version of a payment account associated with the second offering.

5. The computing system of claim 4, wherein the instructions further cause the at least one processor to:
cause the digital version of the payment account to be tokenized into a tokenized digital version of the payment account; and
automatically store the tokenized digital version of the payment account in a digital wallet associated with the user.

6. The computing system of claim 5, wherein the instructions further cause the at least one processor to cause the digital version of the payment account to be tokenized by transmitting payment account details of the payment account to a digital enablement service (DES).

7. The computing system of claim 1, wherein the first offering comprises a loan offering and wherein the application data comprises income data associated with the user and address data associated with the user.

8. The computing system of claim 1, wherein the instructions further cause the at least one processor to:
identify a consent to receive payment account offerings, wherein the consent is included in the application data and wherein the second offering comprises at least one payment account offering; and
receive the application data and compare the application data with the one or more sets of stored parameters associated with the second offering in response to identifying the consent.

9. At least one non-transitory computer-readable storage medium with instructions stored thereon that, in response to execution by at least one processor, cause the at least one processor to:
receive application data associated with a user and a first offering via an application programming interface (API);
identify whether the user qualifies for the first offering;
compare the application data with one or more sets of stored parameters associated with a second offering;
based on the application data satisfying at least one set of the one or more sets of stored parameters and therefore qualifying for the second offering:
cause display of a first display area and a second display area at a graphical user interface (GUI) of a user computing device associated with the user, wherein the first display area comprises a confirmation indicating whether the user qualifies for the first offering, and the second display area comprises a description of the second offering along with a user selectable input for responding to the second offering;
receive an input indicating acceptance of the second offering based on selection of the user selectable input; and
initiate activation of credentials associated with the second offering.

10. The at least one non-transitory computer-readable storage medium of claim 9, wherein the instructions further cause the at least one processor to identify whether the user qualifies for the first offering based on at least one of i) a message received by the at least one processor indicating that the user qualifies for the first offering or ii) applying a second set of one or more parameters to the application data.

11. The at least one non-transitory computer-readable storage medium of claim 9, wherein the instructions further cause the at least one processor to compare the application data with the one or more sets of stored parameters associated with the second offering when the user qualifies for the first offering.

12. The at least one non-transitory computer-readable storage medium of claim 9, wherein the instructions further cause the at least one processor to initiate activation of the credentials by automatically provisioning a digital version of a payment account associated with the second offering.

13. The at least one non-transitory computer-readable storage medium of claim 12, wherein the instructions further cause the at least one processor to:
cause the digital version of the payment account to be tokenized into a tokenized digital version of the payment account; and
automatically store the tokenized digital version of the payment account in a digital wallet associated with the user.

14. The at least one non-transitory computer-readable storage medium of claim 13, wherein the instructions further cause the at least one processor to cause the digital version of the payment account to be tokenized by transmitting payment account details of the payment account to a digital enablement service (DES).

15. The at least one non-transitory computer-readable storage medium of claim 9, wherein the first offering comprises a loan offering and wherein the application data comprises income data associated with the user and address data associated with the user.

16. The at least one non-transitory computer-readable storage medium of claim 9, wherein the instructions further cause the at least one processor to:
identify a consent to receive payment account offerings, wherein the consent is included in the application data and wherein the second offering comprises at least one payment account offering; and
receive the application data and compare the application data with the one or more sets of stored parameters associated with the second offering in response to identifying the consent.

17. A method for activating access credentials implemented by at least one processor in communication with at least one memory, the method comprising:
receiving application data associated with a user and a first offering via an application programming interface (API);
identifying whether the user qualifies for the first offering;
comparing the application data with one or more sets of stored parameters associated with a second offering;
based on the application data satisfying at least one set of the one or more sets of stored parameters and therefore qualifying for the second offering:
causing display of a first display area and a second display area at a graphical user interface (GUI) of a user computing device associated with the user, wherein the first display area comprises a confirmation indicating whether the user qualifies for the first offering, and the second display area comprises a description of the second offering along with a user selectable input for responding to the second offering;
receiving an input indicating acceptance of the second offering based on selection of the user selectable input; and
initiating activation of credentials associated with the second offering.

18. The method of claim 17, further comprising identifying whether the user qualifies for the first offering based on at least one of i) a message received by the at least one processor indicating that the user qualifies for the first offering or ii) applying a second set of one or more parameters to the application data.

19. The method of claim 17, further comprising initiating activation of the credentials by:
causing a digital version of the credentials to be tokenized into a tokenized digital version of the credentials; and
automatically storing the tokenized digital version of the credentials in a digital wallet associated with the user.

20. The method of claim 17, further comprising:
identifying a consent to receive payment account offerings, wherein the consent is included in the application data and wherein the second offering comprises at least one payment account offering; and
receiving the application data and compare the application data with the one or more sets of stored parameters associated with the second offering in response to identifying the consent.
